(19) United States
(12) Patent Application Publication
(10) Pub. No.: US 2021/0337440 A1
(43) Pub. Date: Oct. 28, 2021

(54) CELLULAR TELECOMMUNICATIONS NETWORK

(71) Applicant: BRITISH TELECOMMUNICATIONS PUBLIC LIMITED COMPANY, LONDON (GB)

(72) Inventors: Nicholas HEATLEY, London (GB); Arjun PAREKH, London (GB); Douglas FRIPP, London (GB); Richard MACKENZIE, London (GB)

(21) Appl. No.: 17/250,978

(22) PCT Filed: Sep. 6, 2019
(86) PCT No.: PCT/EP2019/073854

§ 371 Date: Apr. 6, 2021

(30) Foreign Application Priority Data
Oct. 8, 2018 (EP) 18199125.8

(51) Int. Cl. H04W 36/00; H04W 36/38; H04W 72/04

(52) U.S. Cl. CPC H04W 36/0066; H04W 72/0473; H04W 36/38

(57) ABSTRACT

This disclosure relates to a method in a cellular telecommunications network, the cellular telecommunications network having a plurality of base stations each having at least one transmitter, each transmitter having at least one coverage area, the method including a first transmitter operating in a first state so as to transmit within a first coverage area according to a first cellular communications protocol only; receiving a request for service according to a second cellular communications protocol in the first coverage area; and, in response, the first transmitter operating in a second state so as to transmit within the first coverage area according to both the first cellular communications protocol and a second cellular communications protocol, wherein the second cellular communications protocol is an older generation than the first cellular communications protocol.

### PRIORITY CLAIM

The present application is a National Phase entry of PCT Application No. PCT/EP2019/073854, filed Sep. 6, 2019, which claims priority from EP Patent Application No. 18199125.8, filed Oct. 8, 2018, each of which is hereby fully incorporated herein by reference.

### TECHNICAL FIELD

The present disclosure relates to a cellular telecommunications network.

### BACKGROUND

Cellular telecommunications networks operate according to particular protocols, such as the Global System for Mobile Telecommunications (GSM), Universal Mobile Telecommunications System (UMTS) and Long Term Evolution (LTE). Each protocol defines its transmission spectrum, which may (at least partially) overlap with that of another protocol. The cellular network may include coverage areas where User Equipment (UE) may receive transmissions from one or more base stations transmitting according to two cellular protocols and, to avoid interference, the network operator must allocate resources in the overlapping parts of the cellular protocols' transmission spectra to only one of these cellular protocols. These spectrum resources should be allocated to each protocol in order to adequately serve the corresponding demand from UEs communicating via that protocol. Any spectrum resources which are allocated to a particular protocol which is above the corresponding demand is considered wasteful, as that spectrum resource could have been allocated to another protocol. Similarly, any processing resource that is allocated to processing transmissions according to a particular protocol that is in excess of the corresponding demand is also considered wasteful.

It is therefore desirable to alleviate some or all of the above problems.

### SUMMARY

According to a first aspect of the disclosure, there is provided a method in a cellular telecommunications network, the cellular telecommunications network having a plurality of base stations each having at least one transmitter, each transmitter having at least one coverage area, the method comprising: a first transmitter operating in a first state so as to transmit within a first coverage area according to a first cellular communications protocol only; receiving a request for service according to a second cellular communications protocol in the first coverage area; and, in response, the first transmitter operating in a second state so as to transmit within the first coverage area according to both the first cellular communications protocol and a second cellular communications protocol, wherein the second cellular communications protocol is an older generation than the first cellular communications protocol.

The method may further comprise: determining that demand for service according to the second communications protocol in the first coverage area is ceasing; and, in response, the first transmitter operating in the first state so as to transmit within the first coverage area according to the first communications protocol only.

The request for service using the second communications protocol in the first coverage area may be based on the first transmitter being a candidate target of a handover from a second transmitter.

Operating in the first state may be to transmit according to the first communications protocol using a frequency band having a first frequency sub-band and a second frequency sub-band, and operating in the second state may be to transmit according to the first communications protocol using the first frequency sub-band and transmitting according to the second communications protocol using the second frequency sub-band.

The method may further comprise: identifying a second transmitter operating in the first state so as to transmit within a second coverage area according to the first communications protocol only, the first and second coverage area being neighboring coverage areas; sending an instructing message to the second transmitter, the instruction message causing the second transmitter to use a first transmission power for transmissions in the first frequency sub-band and a second transmission power for transmissions in the second frequency sub-band, wherein the first transmission power is higher than the second transmission power.

The first transmitter may be part of a first virtualized base station, wherein, in the first state, the first virtualized base station may use a first computing resource for processing communications according to the first communications protocol and, in response to the request for service using the second communications protocol in the first coverage area, the virtualized base station may also use a second computing resource for processing communications according to the second communications protocol.

The first transmitter may be part of a first base station and the second transmitter may be part of a second base station.

The first and second transmitters may both be part of a first base station.

According to a second aspect of the disclosure, there is provided a computer program product comprising instructions which, when the program is executed by a computer, cause the computer to carry out the method of the first aspect of the disclosure. The computer program may be stored on a computer-readable data carrier.

According to a third aspect of the disclosure, there is provided a network node for a cellular telecommunications network, the network node comprising a transmitter, processor and memory configured to cooperate to carry out the steps of the method of the first aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of an embodiment of a cellular telecommunications network of the present disclosure.

FIG. 2 is a schematic diagram of a base station of the cellular network of FIG. 1.

FIGS. 3a to 3g are schematic diagrams of the cellular network being adapted by an embodiment of a method of the present disclosure.

FIG. 4 is a flow diagram illustrating the embodiment of the method of the present disclosure.

### DETAILED DESCRIPTION OF EMBODIMENTS

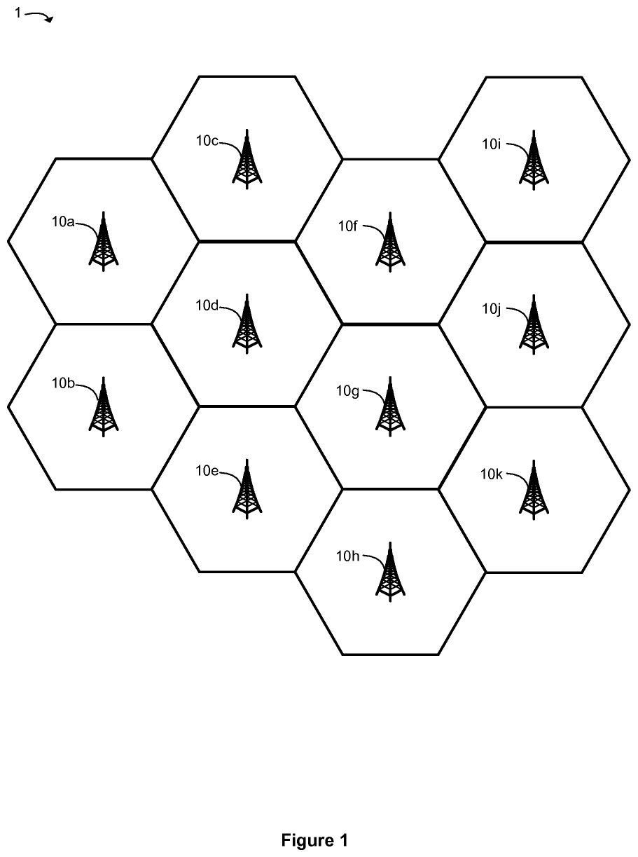

A cellular telecommunications network 1 is shown in FIG. 1. The cellular network 1 includes a first base station 10a to an eleventh base station 10k (i.e. 10a, 10b, 10c, 10d, 10e, 10f, 10g, 10h, 10i, 10j, 10k), having coverage areas illustrated by their respective enveloping hexagons.

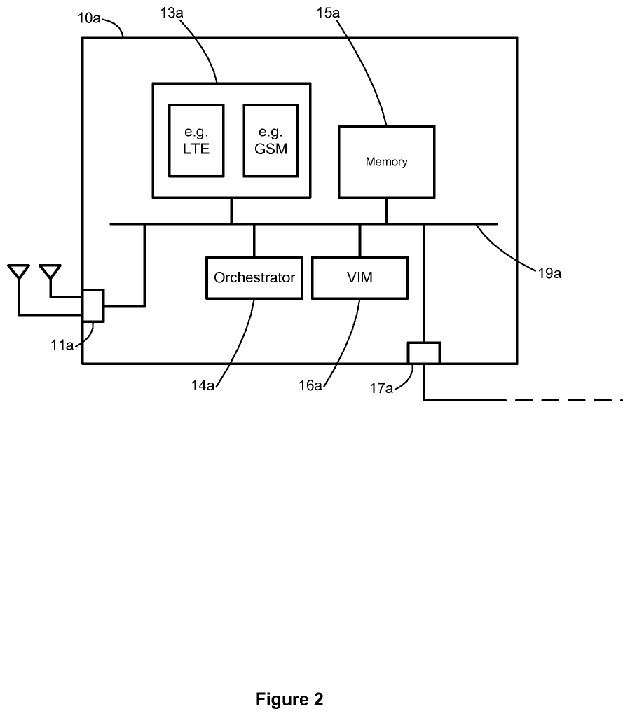

As shown in FIG. 2, the first base station 10a includes a first communications interface 11a configured for communications with a User Equipment (UE), a processor 13a, memory 15a, and a second communications interface 17a for communicating with a cellular core network, all connected via bus 19a. The communications interfaces, processor and memory are configured to cooperate to define a Software Defined Networking (SDN) operating environment, allowing the first base station 10a to reconfigure on demand. Furthermore, the processor 13a implements Network Function Virtualization (NFV) so as to establish a first communication processing environment for communicating with a first UE via a first communication protocol (e.g. LTE), and a second communication processing environment for communicating with a second UE via a second communication protocol (e.g. GSM). To enable these communications, the first communications interface 11a may cooperate with several antennae, in which each antenna operates according to a particular protocol. Furthermore, the first base station 10a may include an NFV orchestrator 14a, for determining the allocation of resources (e.g. spectrum resource), and a Virtualized Infrastructure Manager (VIM) 16a, for implementing the decisions of the NFV orchestrator. In this embodiment, the NFV orchestrator 14a and VIM 16a determine and implement an allocation of spectrum resources in overlapping portions of the respective transmission spectra of the first and second communication protocols.

The second base station 10b to the eleventh base station 10k are all similar to the first base station 10a, such that they all include communications interfaces, processors and memories adapted to cooperate to define SDN operating environments allowing them to reconfigure on demand, and further implement NFV so as to establish multiple communication processing environments such that they may communicate with a first UE via a first communication protocol and a second UE via a second communication protocol.

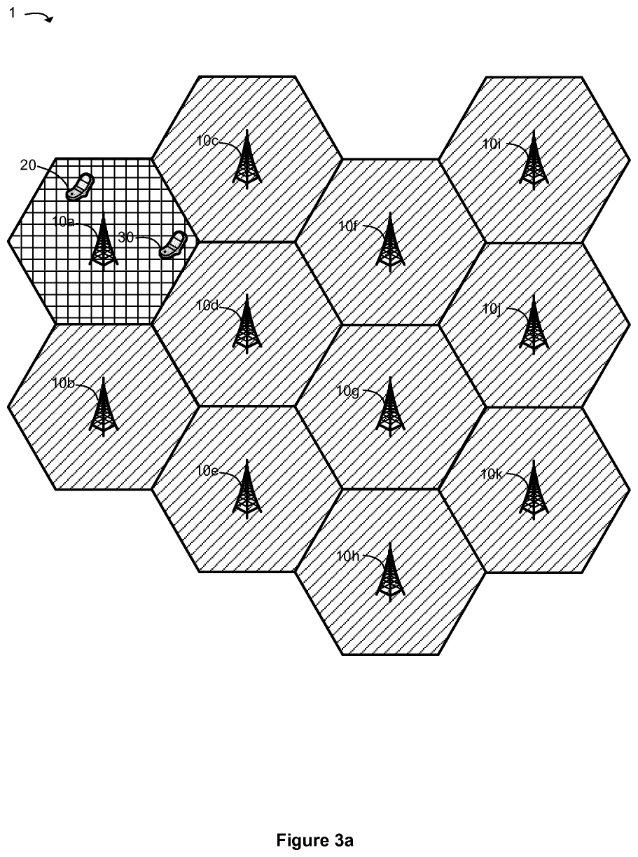

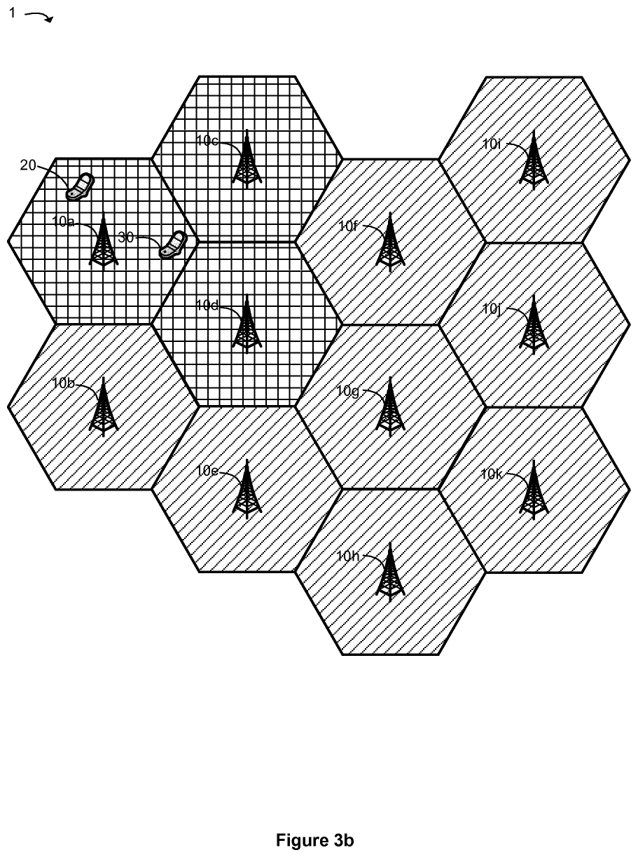

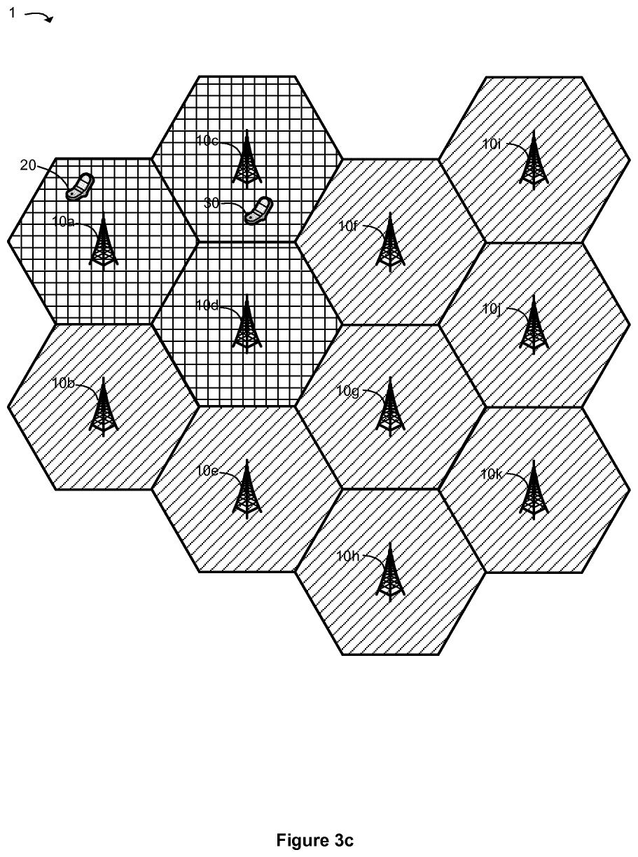

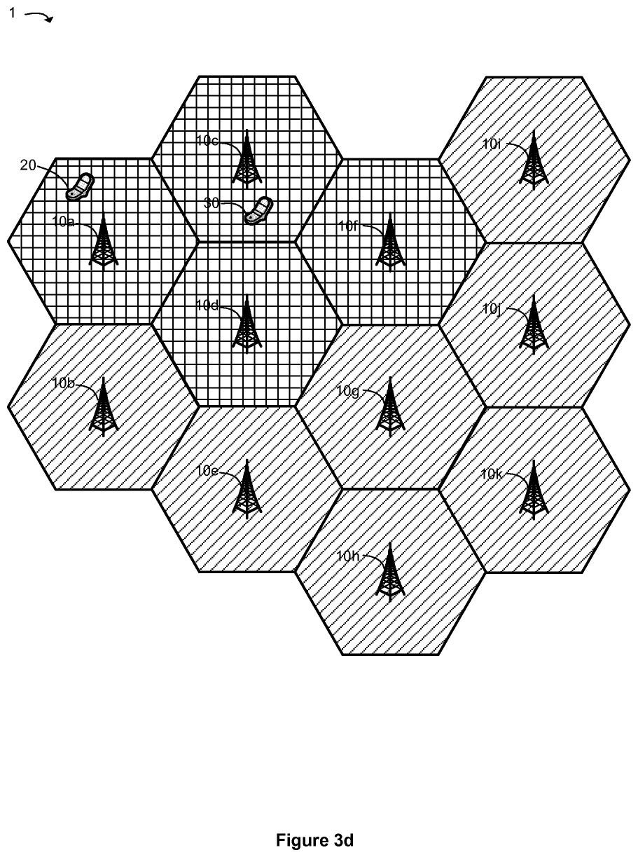

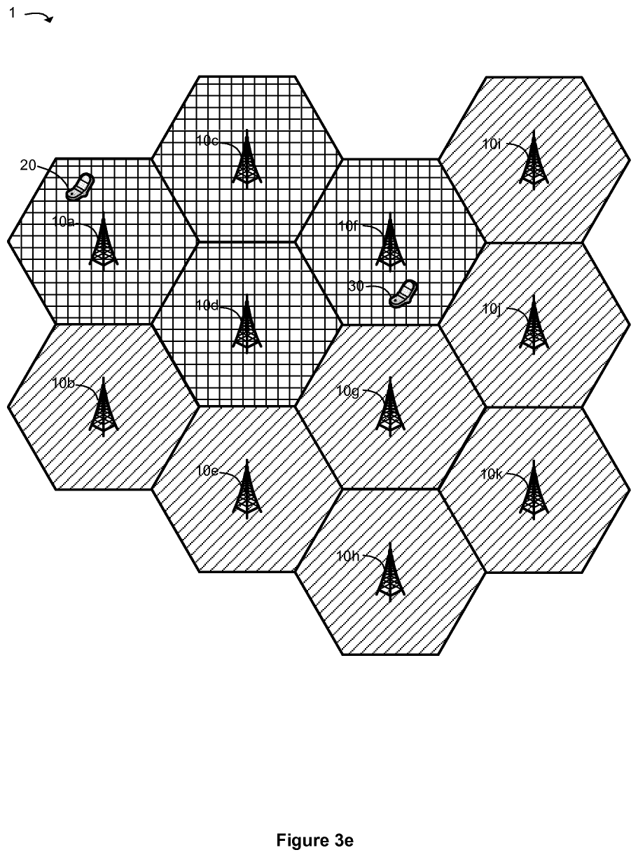

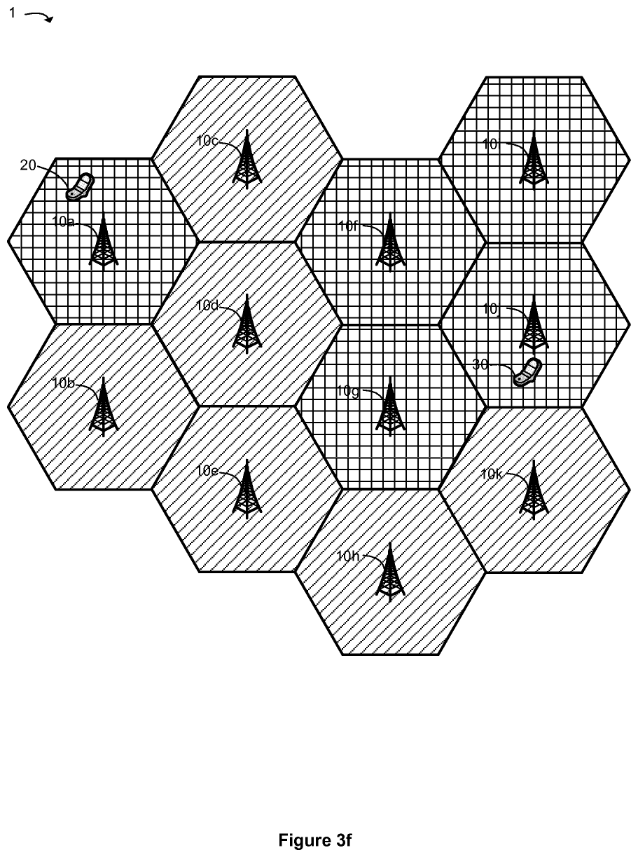

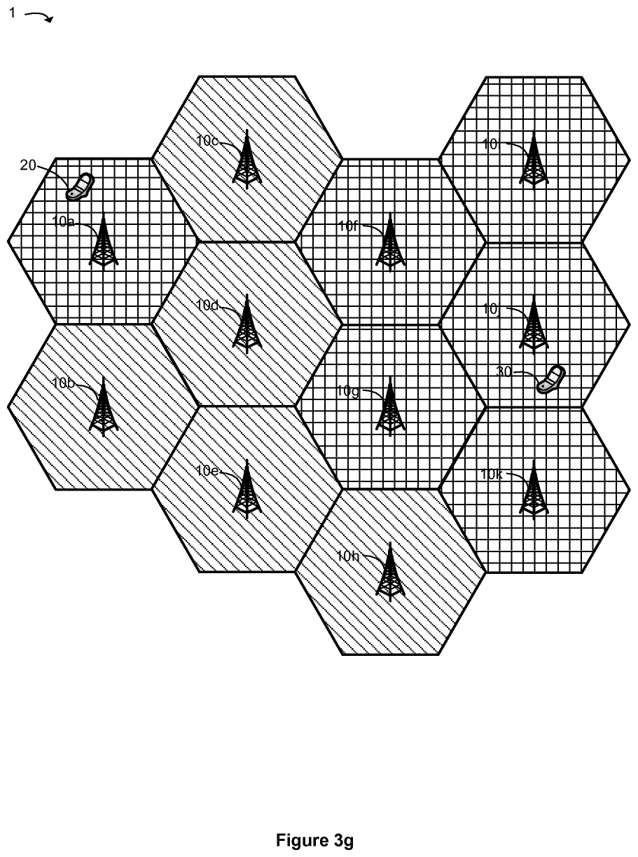

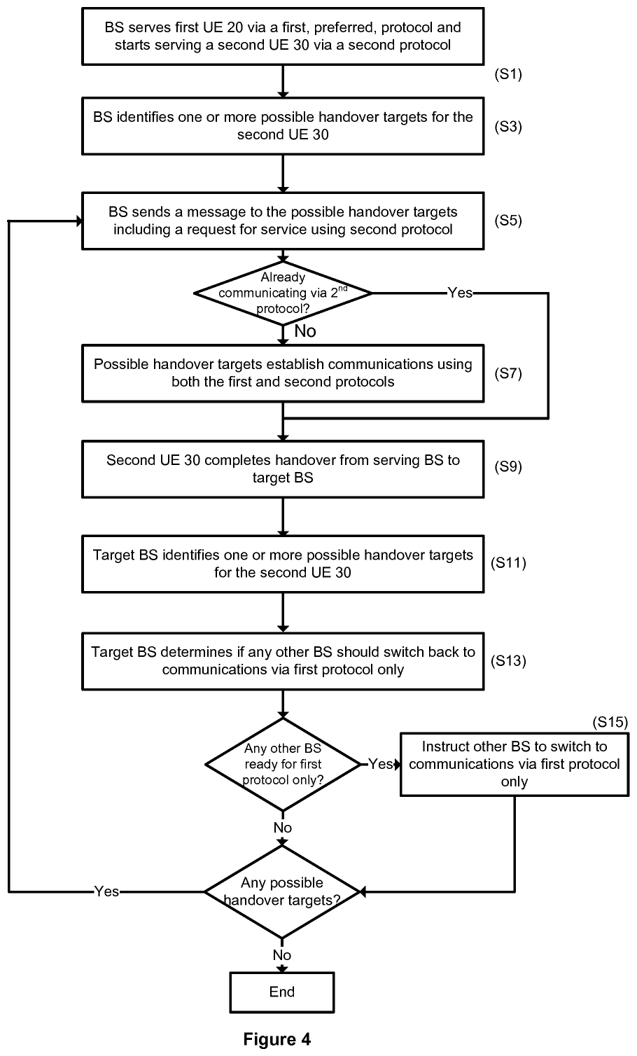

A first embodiment of the present disclosure will now be described with reference to FIGS. 3a to 3g, and the flow diagram of FIG. 4. In an initial configuration, as shown in FIG. 3a, the first base station 10a of the cellular network 1 operates according to both the LTE protocol and the GSM protocol (indicated by the first base station's coverage area having cross hatching in its hexagonal coverage area). The first base station's first communications interface 11a is therefore adapted to send and receive transmissions according to the LTE and GSM protocols (e.g. by interfacing with a first antenna adapted to send and receive transmissions using the LTE protocol and by further interfacing with a second antenna adapted to send and receive transmissions via the GSM protocol), and the first base station's processor 13a may implement a first communications processing environment for processing communications according to the LTE protocol and a second communications processing environment for processing communications according to the GSM protocol. Furthermore, the first base station's NFV orchestrator and VIM are configured to determine and implement an allocation of resources between the first and second communication processing environments, including an allocation of resources of overlapping parts of the LTE and GSM transmission spectra.

In this initial configuration, the first base station 10a serves a first UE 20 via the LTE protocol only. However, the first base station 10a has an active GSM service (via the second antenna and second communication processing environment) due to, for example, the network operator having an obligation to provide GSM service in the first base station's coverage area.

The second to the eleventh base stations 10b . . . 10k of the cellular network 1 are operating according to the LTE protocol only (designated by having a forward diagonal hatching in their respective hexagonal coverage areas). Each base station's first communications interface are therefore adapted to send and receive transmissions according to the LTE protocol (e.g. by interfacing with a first antenna adapted to send and receive transmissions using the LTE protocol). Furthermore, each base station's processor implements a first communications processing environment configured for processing transmissions of the LTE protocol. As noted above, these base stations are capable of communicating with UEs via the GSM protocol (e.g. by using their respective second antennae adapted for communications via the GSM protocol and their respective second communication processing environments configured for processing transmissions of the GSM protocol), but these are not being used in this initial configuration shown in FIG. 3a as there are no UEs demanding GSM service and no obligation for the cellular network to provide GSM service in these coverage areas.

In this embodiment (51 in FIG. 4), the first base station 10a starts serving a second UE 30 via the GSM protocol (for example, the second UE 30 powers on and establishes communications with the first base station 10a, or the second UE 30 switches from an ‘idle’ operational mode to a ‘connected’ operational mode). In S3, the first base station 10a identifies one or more possible handover targets for the second UE 30. The first base station 10a may identify a possible handover target as one or more of its neighboring base stations. To achieve this, the first base station 10a identifies all neighboring base stations (based on, for example, information in its Neighbor Relations Table, NRT) and, in this embodiment, identifies a subset of these neighboring base stations which are possible handover targets based on a comparison of the location of each of the neighboring base stations and the location of the second UE 30. For example, the second UE 30 may report its location to the first base station 10a and the first base station 10a may identify n of the closest neighboring base stations, based on a comparison of the second UE's location to the locations of these neighboring base stations (either known to or queried by the first base station 10a), as the possible handover targets. In another example, the first base station 10a may determine that the second UE 30 is following a known route (e.g. a road or railway track), and therefore identify one or more neighboring base stations having coverage areas along that route as possible handover targets. In a simpler implementation, however, the first base station 10a may identify all of its neighboring base stations as possible handover targets. In this example, the first base station 10a identifies the third and fourth base stations 10c, 10d as possible handover targets.

In S5, the first base station 10a establishes an X2 connection with the third and fourth base stations 10c, 10d (if one hasn't already been established) and sends an X2 message including a) a request for service according to the GSM communications protocol, and b) identifiers for all other base stations that have been identified as possible handover targets for the second UE 30 (from S3). In S7, the third and fourth base stations 10c, 10d respond to the requests for service via the GSM protocol by reconfiguring to operate according to both the LTE and GSM communication protocols. In this example, this is achieved by their respective processors establishing second communication processing environments adapted to process communications according to the GSM protocol (this is in addition to the first communication processing environment adapted to process communications according to the LTE protocol), and their respective first communications interfaces interfacing with a second antenna configured for communications via the GSM protocol (in addition to interfacing with the first antenna configured for communications via the LTE protocol). As the third and fourth base stations 10c, 10d were previously communicating using the entire LTE transmission spectrum, their respective NFV orchestrators must allocate resources in the overlapping portion(s) of the LTE and GSM spectra to either the LTE spectrum or GSM spectrum for use by their first or second antennae respectively (which is implemented by the VIM). At this stage in which there is no actual demand for service via the GSM (as the second UE 30 is still being served by the first base station 10a at this time), then only the resources of the GSM protocol required to establish communications with the second UE 30 in the overlapping portion(s) of the LTE and GSM transmission spectra are allocated for communications according to the GSM protocol. All remaining resources in the overlapping portion(s) of the LTE and GSM transmission spectra are allocated for LTE communications.

Following this reconfiguration, the cellular network 1 is in a state as shown in FIG. 3b, in which the first, third and fourth base stations 10a, 10c, 10d are adapted for communications via LTE and GSM, and the second and fifth to eleventh base stations 10b, 10e . . . 10k are adapted for communications via LTE only. In S9, the second UE 30 moves into the coverage area of the third base station 10c and the first and third base stations 10a, 10c complete a handover so that the third base station 10c now serves the second UE 30 (using the GSM protocol). This is shown in FIG. 3c. At this point, the third base station's NFV orchestrator and VIM may reallocate resources between GSM and LTE in the overlapping portion of their respective spectra in proportion to the current (or estimated) demand for service via these protocols.

Following this handover, the source base station (that is, the first base station 10a) and the other base stations identified as possible handover targets for the second UE 30 when it was positioned in the coverage area of the source base station (that is, the fourth base station 10d) initially continue to communicate via both the LTE and GSM protocols, even though the second UE 30 is now within the coverage area of the third base station 10c. It will become apparent, upon review of the following description, how and when the source base station and possible handover target base stations that did not become the target base station switch back to LTE communications only.

In S11, the third base station 10c identifies one or more possible handover targets for the second UE 30 in its new position in the third base station's coverage area. In this example, this includes the first, fourth and sixth base stations 10a, 10d, 10f. In S13, the third base station 10c then determines if any other base station should switch back to communications via LTE only (i.e. and therefore reallocate all resources to LTE communications). This is achieved by the third base station 10c by identifying any base station that was either 1) the source base station of the handover to the third base station 10c (that is, in this iteration, the first base station 10a) but not one of the newly identified possible handover targets for the second UE 30 from the third base station's coverage area (the first, fourth and sixth base stations 10a, 10d, 10f), or 2) any of the other possible handover target base stations for the second UE 30 when the second UE 30 was being served by the source base station (that is, in this iteration, the fourth base station 10d) but not one of the newly identified possible handover targets for the second UE 30 from the third base station's coverage area (the first, fourth and sixth base stations 10a, 10d, 10f). In this iteration, no base stations are identified that meet at least one of these criteria.

Nonetheless, as the third base station 10c positively identified possible handover targets, the process loops back to step S5 in which the third base station 10c sends a message to these identified base stations including a) a request for service via the GSM protocol, and b) identifiers for all identified possible handover targets (the first, fourth and sixth base stations 10a, 10d, 10f). As the first and fourth base stations 10a, 10d are already providing GSM service, they ignore this request for service via the GSM protocol, but the sixth base station 10f responds to this request by establishing communications via both the LTE and GSM protocols (step S7). Following this reconfiguration, the cellular network 1 is in a state as shown in FIG. 3d, in which the first, third, fourth and sixth base stations 10a, 10c, 10d, 10f are adapted for communications via LTE and GSM, and the second, fifth and seventh to eleventh base stations 10c, 10e, 10g . . . 10k are adapted for communications via LTE only. In a second iteration of step S9, the second UE 30 moves into the coverage area of the sixth base station 10f and the third and sixth base stations 10c, 10f complete a handover so that the sixth base station 10f now serves the second UE 30 (using the GSM protocol). This is illustrated in FIG. 3e.

In a second iteration of S11, the sixth base station 10f identifies one or more possible handover targets for the second UE 30 in its new position in the sixth base station's coverage area. In this example, this includes the third, fourth, seventh, ninth and tenth base stations 10c, 10d, 10g, 10i, 10j. In a second iteration of S13, the sixth base station 10f then determines if any other base station should switch back to communications via LTE only by identifying any base station that was either 1) the source base station of the handover to the sixth base station 10f (that is, in this iteration, the third base station 10c) but not one of the newly identified possible handover targets for the second UE 30 from the sixth base station's coverage area (the third, fourth, seventh, ninth and tenth base stations 10c, 10d, 10g, 10i, 10j), or 2) any of the other possible handover target base stations for the second UE 30 when the second UE 30 was being served by the source base station (that is, in this iteration, the first and fourth base stations 10a, 10d), but not one of the newly identified possible handover targets for the second UE 30 in its new position in the sixth base station's coverage area (the third, fourth, seventh, ninth and tenth base stations 10c, 10d, 10g, 10i, 10j). In this second iteration, the first base station 10a is identified as one that should switch back to communications via LTE only. Accordingly, in S15, the sixth base station 10f sends a message (e.g. via X2) to the first base station 10a indicating that it may switch back to communications via LTE only. In response, the first base station 10a determines whether it may switch back to communications via LTE only (that is, disable GSM communications). In this example, the first base station 10a has an obligation to provide GSM service, so this message is ignored.

As the sixth base station 10f positively identified possible handover targets, the process loops back to S5 in which the sixth base station 10f sends a message to these identified base stations including a) a request for service via the GSM protocol, and b) identifiers for all identified possible handover targets (the third, fourth, seventh, ninth and tenth base stations 10c, 10d, 10g, 10i, 10j). In S7 to S15, the process continues to establish communications via the LTE and GSM protocols in these identified possible handover targets, to complete the handover of the second UE 30 (in the third iteration, to the tenth base station 10j), to identify any base stations that are possible handover targets now the second UE 30 is served by the tenth base station 10j, and to determine if any other base station may switch back to LTE communications only (in this third iteration, the third and fourth base stations 10c, 10d). The third and fourth base stations 10c, 10d therefore react to the message from the sixth base station 10f (in S15) that they may switch back to LTE communications only by reconfiguring their respective processors by dropping their second communications environments (such that only their first communications environments via the LTE protocol remains) and by no longer interfacing with their second antennae. This is illustrated in FIG. 3f.

Accordingly, this embodiment of the method operates in an iterative manner to dynamically reconfigure base stations in the cellular network 1 to enable communications via particular protocols when a base station is serving, or may soon serve, a UE via that particular protocol. This allows base stations to completely disable communications via a protocol that isn't being used, thus allowing all spectra resources in an overlapping portion of that protocol with any other protocol to be reallocated to the other protocol and allowing all processing resources to be allocated to the other protocol. This is not realized in the prior art whereby demand for a particular protocol is monitored and the resources are allocated proportionately, as the base station must use some resources in those overlapping portions of their respective spectra to enable such monitoring to occur.

In an enhancement to the above embodiment, any neighboring base station to a base station that transmits using both first and second protocols is configured to mitigate interference in the overlapping portion(s) of the transmission spectra of these first and second protocols. This is achieved by these neighboring base stations (e.g. the second, third, fourth, fifth and eighth base stations 10b, 10c, 10d, 10e, 10h of FIG. 3g) reducing the transmit power of transmissions in the overlapping portion(s) of the transmission spectra (this is illustrated by their hexagonal coverage areas having backward diagonal hatching). This may be to a particular percentage of the transmission power of the non-overlapping portion(s) of their transmission spectra, or to avoid using these overlapping portion(s) at all. Furthermore, the reduction in transmit power may be in one or both of downlink and uplink transmissions. However, this feature is non-essential.

The skilled reader will also understand that it is non-essential for the base stations to be virtualized to realize the advantages of embodiments of the disclosure. That is, the base stations may have physical hardware dedicated to each protocol, and the base station may then enable and disable communications via a particular protocol in response to the request for service according to that protocol. Furthermore, it is non-essential for the first and second protocols to be transmitted from the same transmitter of a particular base station, but different transmitters of the same or different base stations (so long as they cover a particular coverage area).

In the above embodiment, base stations receive the request for service via the second protocol in response to a determination that they are likely handover targets for a UE using the second protocol. However, this is non-essential. For example, to provide service to UEs via a second protocol in a base station operating according to a first protocol only when the UE is present in the base station's coverage area without a transfer event (e.g. the UE switches on inside that base station's coverage area), the base station may receive a request for service via the second protocol from a neighboring base station that receives a signal from the UE. Alternatively, the base station may operate a periodic timer which, upon expiration, triggers a request for service via the second protocol at that base station in order to establish communications with the UE. In a further example, the request for service may be based on another trigger, such as a prediction or determination that the UE configured for the second protocol is about to switch on in the base station's coverage area.

In the above embodiment, the first protocol was LTE and the second protocol was GSM. However, the skilled person will understand that the benefits of embodiments of the disclosure may be realized using any two protocols, and also realize that the first protocol may be considered a preferred protocol to the second protocol, such that the second protocol is only used when there is demand for the second protocol. It is likely that the first, preferred, protocol, would be of a more recent generation (e.g. n^{th} generation) that the second protocol (e.g. (n−1)^{th} generation or (n−x)^{th} generation). Furthermore, benefits may also be realized when the two protocols do not have any overlapping portion in their respective coverage area, as the invention will at least mitigate any waste of processing resource when both protocols are unnecessarily in use. The skilled person will also realize that embodiments of the present disclosure may be implemented for base stations adapted for transmissions according to two or more protocols.

The above embodiment is practiced in a distributed manner such that all messaging is between base stations and all decisions are made by a base station. However, the skilled person will also understand that a centralized version of this method may also be used, in which some or all messaging is transmitted via one or more controlling entities and some or all decisions are made by one or more controlling entities.

Furthermore, in the above embodiment, all neighboring base stations to a base station serving the second UE become possible handover targets. However, this is non-essential and a subset of these (e.g. to not include those which are highly unlikely to be a handover target) may be identified instead.

The skilled person will understand that any combination of features is possible within the scope of the invention, as claimed.

1. A method in a cellular telecommunications network, the cellular telecommunications network having a plurality of base stations each having at least one transmitter, each transmitter having at least one coverage area, the method comprising:
a first transmitter operating in a first state so as to transmit within a first coverage area according to a first cellular communications protocol only;
receiving a request for service according to a second cellular communications protocol in the first coverage area; and, in response,
the first transmitter operating in a second state so as to transmit within the first coverage area according to both the first cellular communications protocol and the second cellular communications protocol, wherein the second cellular communications protocol is an older generation than the first cellular communications protocol.

2. The method as claimed in claim 1, further comprising:
determining that demand for service according to the second cellular communications protocol in the first coverage area is ceasing; and, in response,
the first transmitter operating in the first state so as to transmit within the first coverage area according to the first cellular communications protocol only.

3. The method as claimed in claim 1, wherein the request for service using the second cellular communications protocol in the first coverage area is based on the first transmitter being a candidate target of a handover from a second transmitter.

4. The method as claimed in claim 1, wherein operating in the first state is to transmit according to the first cellular communications protocol using a frequency band having a first frequency sub-band and a second frequency sub-band, and operating in the second state is to transmit according to the first cellular communications protocol using the first frequency sub-band and transmitting according to the second cellular communications protocol using the second frequency sub-band.

5. The method as claimed in claim 4, further comprising:
identifying a second transmitter operating in the first state so as to transmit within a second coverage area according to the first cellular communications protocol only, the first coverage area and the second coverage area being neighboring coverage areas; and
sending an instructing message to the second transmitter, the instructing message causing the second transmitter to use a first transmission power for transmissions in the first frequency sub-band and a second transmission power for transmissions in the second frequency sub-band, wherein the first transmission power is higher than the second transmission power.

6. The method as claimed in claim 1, wherein the first transmitter is part of a first virtualized base station, wherein, in the first state, the first virtualized base station uses a first computing resource for processing communications according to the first cellular communications protocol and, in response to the request for service using the second cellular communications protocol in the first coverage area, the virtualized base station also uses a second computing resource for processing communications according to the second cellular communications protocol.

7. The method as claimed in claim 3, wherein the first transmitter is part of a first base station and the second transmitter is part of a second base station.

8. The method as claimed in claim 3, wherein the first transmitter and the second transmitter are both part of a first base station.

9. A non-transitory computer-readable storage medium storing a computer program product comprising instructions which, when the computer program product is executed by a computer, cause the computer to carry out the method of claim 1.

10. (canceled)

11. A network node for a cellular telecommunications network, the network node comprising a transmitter, processor and memory configured to cooperate to carry out the method of claim 1.
